(19) United States
(12) Patent Application Publication
(10) Pub. No.: US 2015/0082226 A1
(43) Pub. Date: Mar. 19, 2015

(54) Systems and Methods for Providing Software Simulation of Human Anatomy and Endoscopic Guided Procedures

(71) Applicant: Win Liu, Katy, TX (US)

(72) Inventor: Win Liu, Katy, TX (US)

(73) Assignee: SHARP VISION SOFTWARE LLC, KATY, TX (US)

(21) Appl. No.: 14/490,224

(22) Filed: Sep. 18, 2014

Related U.S. Application Data
(60) Provisional application No. 61/879,643, filed on Sep. 18, 2013.

(51) Int. Cl. G06F 3/0484; G06F 19/00; G06F 3/0488

(52) U.S. Cl. CPC G06F 3/0484; G06F 3/0488; G06F 19/3437
USPC 715/771

(57) ABSTRACT

In an example embodiment of the present disclosure, a computer-implemented system for providing endoscopic simulations includes a 3D organ model and a graphical user interface (GUI) displayed on a screen. The GUI includes a device model simulating a medical device displayed in the GUI and configured to be manipulated by a first user input to the GUI. The GUI also includes an internal view of the 3D organ model, wherein the internal view is controlled by the manipulation of the device model and simulates a view captured by the simulated medical device. The GUI also includes an external view of the 3D organ model, wherein the external view is controlled by a second user input to the GUI.

### RELATED APPLICATIONS

The present application claims priority under 35 U.S.C. §119(e) to U.S. Provisional Patent Application No. 61/879,643, filed Sep. 18, 2013, and titled “System And Method for Providing Software Simulation With 3D Anatomy Model For Human Anatomy Learning And Training Of Endoscopic. Ultrasound Guided Procedures,” the entire content of which is incorporated herein by reference.

### TECHNICAL FIELD

The present disclosure relates generally to simulating medical procedures on an electronic device. Specifically, the present disclosure relates to a software solution which provides interactive simulation of medical procedures and the anatomy, devices, and techniques involved in such procedures.

### BACKGROUND

Before physicians can perform certain medical procedures on live patients, they must become familiar with the devices, anatomy, and techniques involved in performing such procedures. This is typically done through a training process. A typical training may consist of classroom lectures and/or hands-on practice with animals or standardized patients. However, each of these components includes various shortcomings. For example, classroom lectures can provide only knowledge and theory rather than experience. Since performing a medical procedure is a physical task requiring mastery of a physical skills, lectures are unable to provide adequate training. While hands-on practice of performing procedures on animals provides a level of familiarity with the devices and tools involved, animals have anatomy that is different than that of a human. In order to perform a procedure on standardized patients, the physician typically must already have certain qualifications. However, there are also many restrictions regarding what types of procedures can be performed on standardized patients and under certain. conditions.

One current type of training system is a procedure simulation system, which allows a user to perform simulated medical procedures. However, these systems require a suite of specialty hardware, resulting in a very large and costly physical system. These systems are generally stationary as they are too heavy to be easily transported, and are typically only used in large hospitals. Thus, there is currently no low-cost and easily accessible training means of simulating medical procedures and the devices, anatomy, and techniques involved in such procedures.

### SUMMARY

In an example embodiment of the present disclosure, a computer-implemented system for providing endoscopic simulations includes a 3D organ model and a graphical user interface (GUI) displayed on a screen. The GUI includes a device model simulating a medical device displayed in the GUI and configured to be manipulated by a first user input to the GUI. The GUI also includes an internal view of the 3D organ model, wherein the internal view is controlled by the manipulation of the device model and simulates a view captured by the simulated medical device. The GUI also includes an external view of the 3D organ model, wherein the external view is controlled by a second user input to the GUI.

In another example embodiment of the present disclosure, a computer-implemented system for providing medical device simulations includes a graphical user interface (GUI) configured to receive one or more of user inputs. The system also includes a device module configured to receive an input from the GUI in accordance with a first user input of the one or more user inputs. the device module includes a 3D device model of a medical device, and the 3D device model is displayed in the GUI, wherein a display angle and configuration of the 3D device model is determined based on the first user input, and wherein the first user input includes a simulated use of the medical device. The system further includes an organ module configured to receive an input from the GUI, the device module, or both, in accordance with the first user input to the device module. The organ module includes a 3D organ model, an internal organ sub-module comprising an internal view of the 3D organ model, wherein the internal view changes according to the first user input to the device module. The organ module also includes an external organ sub-module comprising an external view of the 3D organ model, the external organ sub-module configured to receive an input from the device module, an input from the GUI according to a second user input of the one or more user inputs, or both. The angle and configuration of the external view is changeable according to the second user input or the input from the device module.

In another example embodiment of the present disclosure, a method of simulating endoscopy includes receiving one or more selection inputs from a user, the one or more selection inputs comprising at least one of a device selection, an accessory selection, or an organ selection. The method includes displaying a graphical user interface (GUI) on a screen according to the received one or more selection inputs, wherein the graphical user interface includes a graphical model of a medical device and a graphical model of an organ. The method also includes receiving a control input to the GUI, the control input comprising a manipulation of the graphical model of the medical device. The method also includes displaying a real-time configuration of the graphical model of the medical device based on the control input. The method further includes displaying a real-time configuration of the graphical model of the organ based on the control input.

### BRIEF DESCRIPTION OF THE DRAWINGS

For a more complete understanding of the disclosure and the advantages thereof, reference is now made to the following description, in conjunction with the accompanying figures briefly described as follows:

FIG. 1 illustrates a block diagram depicting certain components of an electronic device on which the present system can be implemented, in accordance with aspects of the present disclosure.

FIG. 2 illustrates the present simulation system and a graphical user interface (GUI) of the system, in accordance with example embodiments of the present disclosure.

FIG. 3 illustrates a diagrammatical view of the simulation system, in accordance with example embodiments of the present disclosure.

FIG. 4 illustrates a method of providing a medical simulation, in accordance with example embodiments of the present disclosure.

The drawings illustrate only example embodiments of the disclosure and are therefore not to be considered limiting of its scope, as the disclosure may admit to other equally effective embodiments. The elements and features shown in the drawings are not necessarily to scale, emphasis instead being placed upon clearly illustrating the principles of example embodiments of the present disclosure. Additionally, certain dimensions may be exaggerated to help visually convey such principles.

### DETAILED DESCRIPTION OF EXAMPLE EMBODIMENTS

In the following paragraphs, the present disclosure will be described in further detail by way of examples with reference to the attached drawings. In the description, well known components, methods, and/or processing techniques are omitted or briefly described so as not to obscure the disclosure. As used herein, the “present disclosure” refers to any one of the embodiments of the disclosure described herein and any equivalents. Furthermore, reference to various feature(s) of the “present disclosure” is not to suggest that all embodiments must include the referenced feature(s).

The present disclosure describes a system and method for providing an anatomy model using a simulation software. The simulation software also provides interactive 3D models of various medical devices as well as interactions between medical devices and the anatomy. The simulation software allows for visual and interactive learning of anatomy and medical procedures such as endoscopic procedures like endoscopic ultrasound guided procedures. For example, the simulation software can visualize virtual endoscopic devices and procedures with respect to three-dimensional anatomy models. Although endoscopic devices and tools are used herein as an example in order to illustrate the functional concepts of the present disclosure, other embodiments and applications of the present disclosure can include various other types of medical devices and procedures. The present system and method provide simulation of a 3D anatomy model by eliminating the need for simulation hardware while providing simulation that is platform-independent and capable of operating on various electronic devices such as laptops, desktop computers, and a mobile devices.

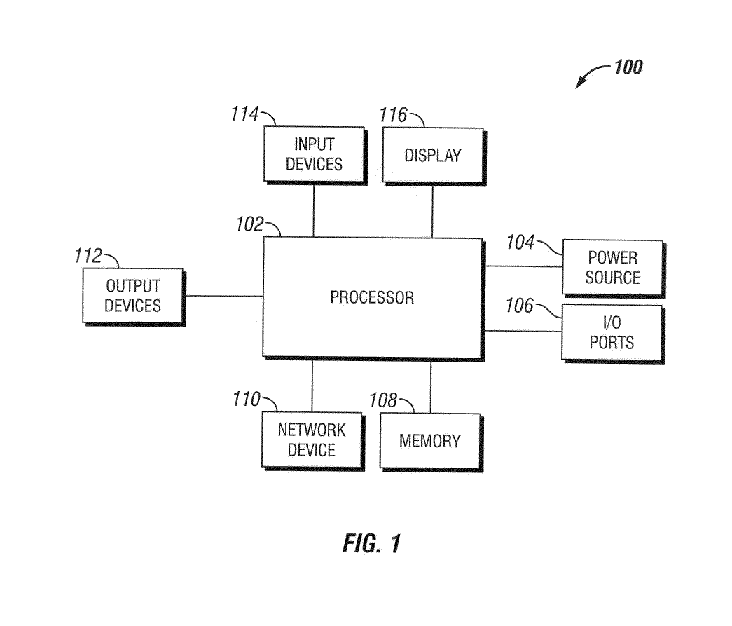

FIG. 1 illustrates a block diagram depicting certain components of such electronic devices 100 on which the present system can be implemented, in accordance with aspects of the present disclosure. Specifically, the illustrated components enable the electronic devices 100 to function in accordance with the techniques discussed herein. The various functional blocks shown in FIG. 1 may comprise hardware elements (including circuitry), software elements (including computer code stored on a computer-readable medium), or a combination of both hardware and software elements. FIG. 1 is merely one example of a particular implementation and set of components intended to illustrate, but not limit, the types of components that may be present in the electronic device 100. In such an example embodiment, the electronic device 100 includes a processor 102, a power source 104, one or more I/O ports 106, a memory 108, an output device 112, an input device 114, and a display 116. In certain example embodiments, the electronic device 100 also includes a network device 110.

The processor 102 controls the general operation of the electronic device 100 and provides the processing capability to execute an operating system, programs, user and application interfaces, and any other functions of the electronic device 100. The processor 102 may include one or more microprocessors, such as a “general-purpose” microprocessor, a special-purpose microprocessors and/or application-specific microprocessors (ASICs), or some combination of such processing components. For example, the processor 102 may include one or more reduced instruction set (RISC) processors, as well as graphics processors. video processors, audio processors and/or related chip sets. As will be appreciated, the processor 102 may be coupled to one or more data buses for transferring data and instructions between the various components of the electronic device 100.

The power source 104 provides power to the electronic device 100 in order to carry out its functions. The power source 104 may be provided as one or more batteries, such as a lithium-ion polymer battery. The battery may be user-removable or may be secured within the housing of the electronic device 100, and may be rechargeable. Additionally, the power source 104 may include AC power, such as provided by an electrical outlet, and the electronic device 100 may be connected to the power source 104 via a power adapter, which processes incoming power into a form usable by the electronic device 100.

The I/O ports 106 may include ports configured to connect to a variety of external devices, such as an external power source, headphones, or other electronic peripherals (such as handheld devices and/or computers, printers, projectors, external displays, modems, docking stations, and so forth). The I/O ports 106 may support any interface type, such as a universal serial bus (USB) port, a video port, a serial connection port, an IEEE-1394 port, an Ethernet or modem port, and/or an AC/DC power connection port.

The instructions or data to be processed by the processor 102 may be stored in a computer-readable medium, such as the memory 108, which may be provided as a volatile memory, such as random access memory (RAM) or as a non-volatile memory, such as read-only memory (ROM), or as a combination of one or more RAM and ROM devices. For example, the memory 108 may store firmware for the electronic device 100, such as a basic input/output system (BIOS), an operating system, various programs, applications, or any other routines that may be executed on the electronic device 100, including user interface functions, processor functions, and so forth. The memory may include non-volatile storage such as flash memory, a hard drive, or any other optical, magnetic, and/or solid-state storage media, or some combination thereof. The non-volatile storage may be used to store data files such as firmware, data files, software programs and applications, wireless connection information, personal information, user preferences, and any other suitable data.

The network device 110, which may not be present in all embodiments, may be a wireless network interface card providing wireless connectivity over any 802.11 standard or any other suitable wireless networking standard. The network device 110 may allow the electronic device 100 to communicate over a network, such as a Local Area Network (LAN), Wide Area Network (WAN), such as an Enhanced Data Rates for GSM Evolution (EDGE) network for a 3G data network (e.g., based on the IMT-2000 standard), or the Internet. Additionally, the network device 110 may provide for connectivity to a personal area network, such as a Bluetooth network, an IEEE 802.15.4 (e.g., ZigBee) network, or an ultra wideband network (UWB). The network device 110 may also include hardware and/or software capable to enabling communication over other known or new communication protocols and networks.

The output devices 112 may include one or more components which provide various types of informational output or feedback from the electronic device 100. The output device 112 may include display screens, speakers, lights, as well as tactile feedback devices such a vibrating motor.

The input devices 114 may include one or more components which provide a means for a user or another device to provide inputs to the electronic device 100. Such input devices 114 may be configured to control a function of the electronic device 100, applications running on the electronic device 100, and/or any interfaces or devices connected to or used by the electronic device 100. For example, the input devices 114 may allow a user to navigate a displayed user interface or application interface. Examples of the input devices 114 may include buttons, sliders, switches, control pads, keys. knobs, scroll wheels, keyboards, mice. touchpads, touchscreens, and so forth

The display 116 may be used to display various images generated by the electronic device 100. In one embodiment, the display 116 be a liquid crystal displays (LCD). Additionally, in certain embodiments of the electronic device 100, the display 116 may be provided in conjunction with a touch-sensitive element, such as a touchscreen, that may be used as part of the control interface for the electronic device 100. Specifically, in certain example embodiments, one or the input devices 114 and the display 116 are provided together, such as in the case of a touchscreen. In such embodiments, the user may select or interact with displayed interface elements via the touchscreen. In this way, the displayed interface may provide interactive functionality, allowing a user to navigate the displayed interface by touching the display 116. For example, user interaction with the input devices 114, such as to interact with a user or application interface displayed on the display 116, may generate electrical signals indicative of the user input. These input signals may be routed via suitable pathways, such as an input hub or data bus, to the one or more processors 102 for further processing.

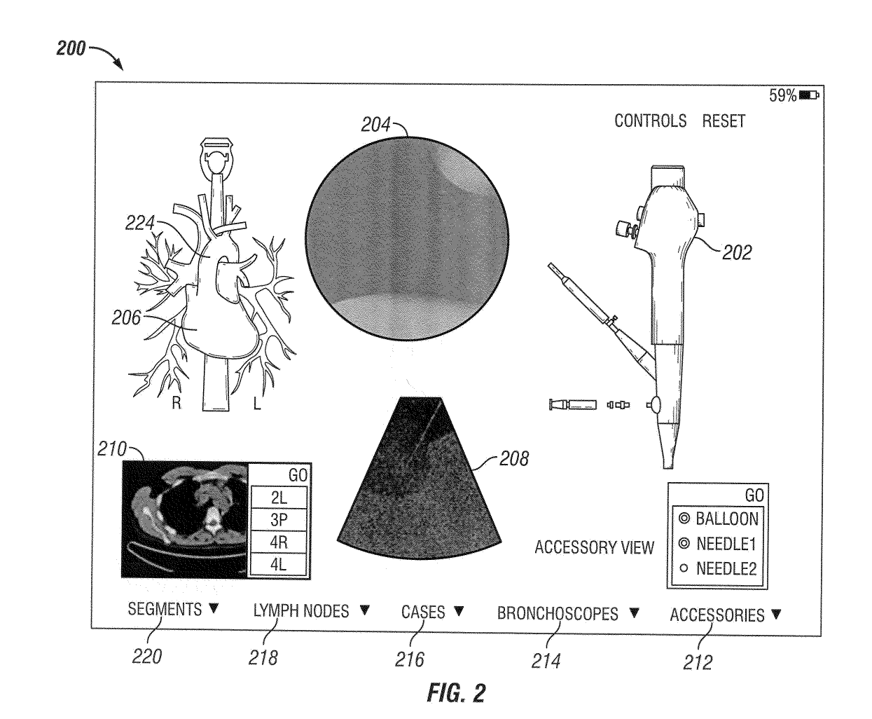

FIG. 2 illustrates the simulation system 200 through a graphical user interface (GUI) of the system 200, in accordance with example embodiments of the present disclosure. In certain example embodiments, the system 200 and GUI are implemented via a tablet, a laptop computer, a desktop computer, a smartphone, and specialized electronic device, or any electronic device having the components of FIG. 1. In certain example embodiments, the GUI includes a virtual device model 202, an internal organ view 204, and an external organ view 206. In certain example embodiments, the internal organ view 204 and the external organ view 206 are generated from a virtual organ model. In certain example embodiments, the GUI also includes an ultrasound image 208, and a computed tomography (CT) image 210. The example configuration of the GUI 200 provides endoscopic anatomy learning and procedure simulation that is applicable to all endoscopic disciplines including, but not limited to. gastrointestinal, respiratory, and reproductive. Images of the internal anatomy are visualized in a 3D space and have labels to mark key anatomical landmarks.

In certain the example embodiments, the virtual device model 202 is a dynamic 3D rendering of an endoscopic medical device. The virtual device model 202 includes all the functions and components of the real medical device, including buttons, selectors, accessories, cameras, and the like. The virtual device model 202 can be manipulated by a user through a user input. For example, the user input can change the viewing angle of the virtual device model 202, cause certain components on the virtual device. model 202 to be actuated, and otherwise alter a state, configuration, or look for the virtual device model 202. The virtual device model 202 is dynamic and responds to the user input. In certain example embodiments, the display 116 is a touchscreen device. In such example embodiments, the user input includes one or more touch actions on the portion of the touchscreen on which the virtual device model 202 is displayed, and are relative to the virtual device model 202. For example, a horizontal swipe across the virtual device model 202 may cause the virtual device model 202 to rotate in the direction of the swipe. In another example, a point touch of a bottom on the virtual device model 202 may cause the virtual device model 202 to respond in a manner which simulates the response of a real device when such a button is depressed on the real device. In another example, a sliding motion on a portion of the virtual device model 202 may cause that portion of the virtual device model 202 to move accordingly with respect to the rest of the virtual device model 202.

In certain example embodiments, the virtual device model 202 is produced by a device module, which includes the files and executables necessary for displaying the dynamic 3D rendering as well as for processing the user inputs to the virtual device model 202 and producing the appropriate outputs. In certain example embodiments, the outputs may include a change in the displayed view or configuration of the virtual device model 202. For example, a user may toggle a joystick or depressed a button simulated by the virtual device model 202. Thus, the output may include displayed movement of the joystick or displayed depression of the button. In certain example embodiments, the output may also include changes in the internal organ model 204 and/or the external organ model 206.

In certain example embodiments, the GUI further includes a device selector 214 and accessories selector 212, both of which are configured to receive a selection input. In the example embodiments, the system 200 includes a library of different virtual device models 202, selectable through the device selector 214. In certain example embodiments, the library contains several virtual endoscope models, based on real endoscopes manufactured by leading manufacturers. The present system 200 also includes a library of virtual device accessories, such as endoscopic accessories. Endoscopes used in procedures often require peripheral tools or accessories. These include, but are not limited to, needles, balloons, forceps, curettes, etc. The accessories can also be operated via a touchscreen. Actions simulated with accessories include, but are not limited to, introducing a needle via a port on a side of the endoscope, stabbing a bronchial wall and retracting the needle, and introducing, inflating and deflating a balloon.

The internal organ model 204 provides a simulated view of the anatomy from the perspective of the virtual device model 202. Specifically, in certain example embodiments in which the virtual device model 202 is that of an endoscope, the internal organ model 204 simulates the view as seen from the camera of the endoscope. Thus, the view provided by the internal organ model 204 changes according to user manipulation of the virtual device model 202. Specifically, in certain example embodiments, the view follows a point on the virtual device model 202, such as the camera. Thus, movement of the virtual device model 202 causes a corresponding change in the view of the internal organ model 202. Thus, the view provided by the internal organ model 204 is indicative of the position and direction of the device simulated by the virtual device model 202. In certain example embodiments, the virtual device model 202 may have a camera zoom feature, which if activated, brings about a corresponding zoom in the view of the internal organ model 202.

In certain example applications, the user is tasked with navigating the simulated anatomy by manipulating the virtual device model 202 accordingly, directing it in the proper directions. to the proper extent, and deploying the proper functions. In certain example applications, the virtual device model 202 is a simulated bronchoscope and the simulated anatomy is a trachea. Thus, the user can navigate the trachea and perform certain tasks, such as taking a biopsy, by manipulating the virtual device model 202 accordingly. The external organ model 206 provides an external view of the particular anatomy, and can also indicate the position of the scope with a marker 224. In certain example embodiments, the marker 224 also indicates the direction in which the scope is pointed. In certain example embodiments, the external organ model 206 can be manipulated by a user input. For example, a user can rotate or change the viewing angle of the external organ model 206.

In certain example embodiments, various anatomic structures, indicators, and labels can be turned on or off, such as for different organs, lymph nodes, vasculature, or neighboring anatomy. In certain example embodiments, in lieu of manually navigating through the anatomy to find the desired location, the present system and method provide users the option to automatically navigate to a specific anatomical location by entering the name of the desired segment or lymph node. In such example embodiments, a specific lymph node or region can be selected via a location selector 218 in the GUI. In certain example embodiments, the internal organ model 204 and the external organ model 206 are generated by an organ module. The organ module includes 3D renderings of organs and anatomies and the relevant data to enable the functions and features of the organ models 204, 206. Furthermore, the organ module interacts with the device module such that the organ models 204, 206 can respond accordingly to certain user inputs to virtual device model 202.

In certain example embodiments, the system further includes the ultrasound image 208. In certain example embodiments, the virtual device model 202 includes an ultrasound device and the ultrasound image 208 simulates the output of the ultrasound device as the virtual device model 202 navigates the anatomy. The ultrasound image 208 is a dynamic ultrasound image which corresponds to a position of the virtual device model 202.

A typical procedure to be simulated through the present system 200 is a biopsy to confirm a cancer diagnosis, which requires use of Endobronchial Ultrasound Transbronchial Needle Aspiration (“EBUS-TBNA”). Thus, the simulation would include the virtual device model 202 with a needle accessory, the organ models 204, 206, and the ultrasound image 208. The user would be tasked to manipulate the virtual device model 202 and navigate the device to a target location within the anatomy. The user would then manipulate the needle accessory in order to simulate puncturing of the bronchial wall in order to collect the biopsy sample. In certain example embodiments. The present system 200 can provide CT images 210. The CT images 210 are linked to the simulated location of the virtual device model 202. For example, as a bronchoscope navigates the bronchial tree, the CT images 210 changes automatically to match its location. In certain example embodiments, the present system and method provide a library of medical cases, selectable from a case selector 216. Examples of medical cases include, but are not limited to, patient information and a patient chart or medical record, and organ models 204, 206 with affected regions or lesions.

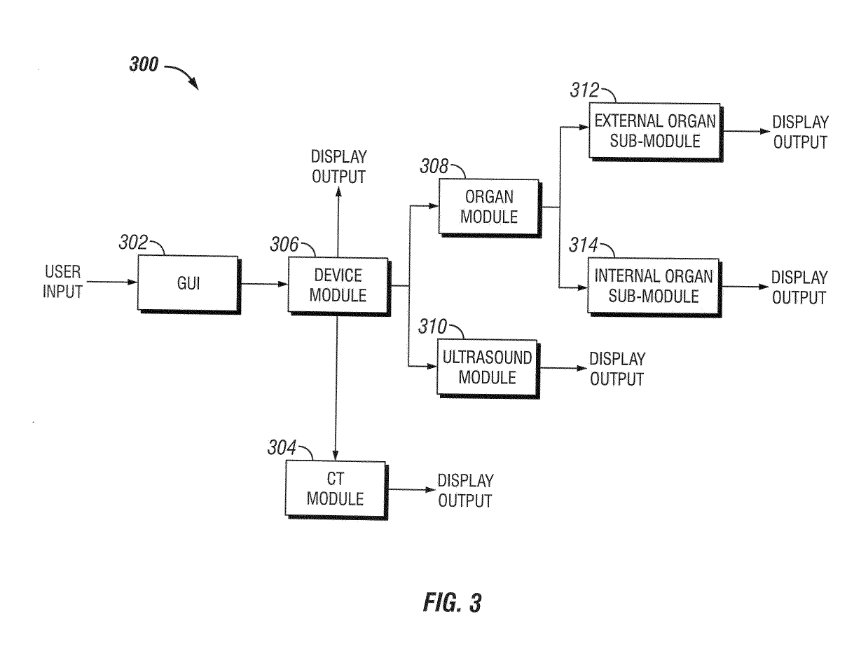

FIG. 3 illustrates a diagrammatical view of the simulation system 300, in accordance with example embodiments of the present disclosure. In certain example embodiments, the system 300 includes a GUT 302, a device module 306, and an organ module 308. In certain example embodiments, the organ module 308 further includes an external organ sub-module 312 and an internal organ sub-module 314. In certain example embodiments, the system 300 includes an ultrasound module 310. In certain example embodiments, the system 300 includes a CT module. In certain example embodiments, the GUI 302 receives a user input. The user input may be in the form of a touch on a touchscreen, a click of a mouse, push of a button, and the like. In certain example embodiments, the device module 306 receives the user input via the GUI 302 when the user input is a manipulation of the virtual device model 202. The device module 306 processes the user input and determines the corresponding output. In certain example embodiments, the output includes an output via the virtual device model 202 such as a change in the displayed virtual device model 202. In certain example embodiments, the output is realized through the organ module 308, and more specifically, through the external and/or internal organ sub-modules 312, 314. In such example embodiments, the output is realized in the internal and external organ models 204, 206 and/or the ultrasound module 310. For example, the output may be a change in the view of the internal organ model 204. Specifically, in certain example embodiments, the output is also realized through the ultrasound module 310. For example, if the user input includes a change in the position of the ultrasound probe, the ultrasound module 310 will output a corresponding ultrasound image. In certain example embodiments, the output is also realized through the CT module 304 in which the displayed CT image 210 may change if the user input causes the virtual device model 202 to simulate navigation into a certain portion of the anatomy. In certain example embodiments, the system 200 includes other modules through which a user input may be processed and through which an output corresponding to the user input may be realized. The other modules may include other visual or numerical outputs or references associated with the virtual device model

In certain example embodiments, the GUI 200 focuses on the external organ model 206, the internal organ model, 204, or both, and does not include the virtual device model 202. Such an embodiment allows one or both of the organ models 204, 206 to take up a substantial portion of the display 116 and allows for more detail interaction and manipulation of the organ models 204, 206. In certain example embodiments, the external organ model 206 is configured to receive a user input through which the user can manipulate the external organ model 206, such as rotating or changing the viewing angle, and zooming in on particular regions. In certain example embodiments, the user input is a touch input to the display 116 when the display 116 is a touchscreen. En certain example embodiments, the external organ model 206 includes one or more organs and/or vasculatures of an anatomical region. In such example embodiments, each of the one or more organs and/or vasculatures can be brought in and out of view with varying levels of transparency. Therefore, various internal structures can be revealed when an outer structure is set to a certain transparency level. Additionally, multiple structures can be seen relative to each other when otherwise one structure may be hidden behind another structure.

In certain example embodiments, the internal organ model 206 illustrates an internal view of the anatomy from a particular point. In certain example embodiments, the view can be set based on a user input, in which the user input is a selection of a point or region on the external organ model 206. The user input may also include a view direction. In certain example embodiments, the organ models 204, 206 can include labels indicating the various structures and lymph nodes on the organ models 204, 206. In certain example embodiments, the GUI 200 also includes text description of the organ models 204, 206 and/or other relevant information regarding the anatomy. In certain such embodiments, the content of the text description may change when the organ models 204, 206 change or are manipulated.

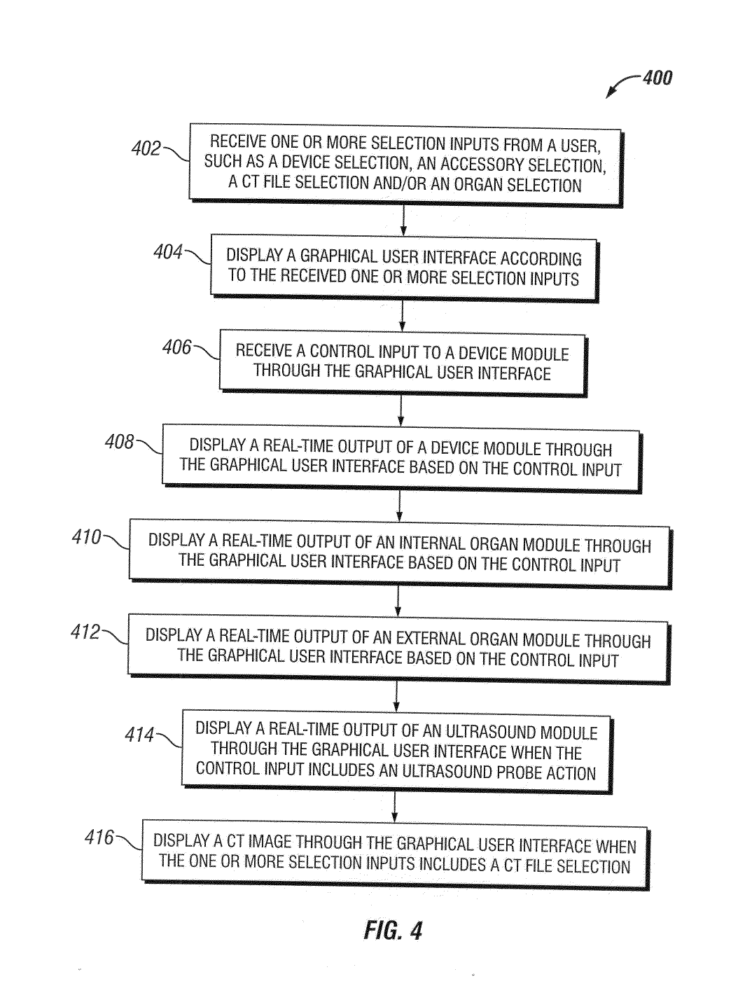

FIG. 4 illustrates a method 400 of providing a medical simulation, in accordance with example embodiments of the present disclosure. In certain example embodiments, the method 400 includes receiving one or more selection inputs from a user (step 402). The selection inputs may include a device selection, an accessory selection, a CT image file selection, and/or an organ selection. This step essentially sets up the system for a particular simulation. The method 400 further includes displaying a GUI in accordance to the one or more received selection inputs (step 404), in which the selected items populate the GUI. The method 400 also includes receiving a control input for a device module through the graphical user interface (step 406). This may include a manipulation of the virtual device model 202 such as rotating or moving the virtual device model 202, activating a button or joystick on the virtual device model 202, and moving the virtual device model 202 with respect to the anatomy.

The method 400 also includes displaying a real-time output of the device module through the graphical user interface based on the control input (step 408). In certain example embodiments, the output includes a change in the virtual device model 202. The method 400 also includes displaying a real-time output of an internal organ module through the graphical user interface based on the control input (step 410). In certain example embodiments, the output includes the internal organ model 204 on the GUI. The method 500 also includes displaying a real-time output of an external organ module through the graphical user interface based on the control input (step 412). In certain example embodiments, the output is the external organ model 206 on the GUI. In certain example embodiment, the method 400 includes displaying a real-time output of an ultrasound module through the graphical user interface based on the control input (step 414). In certain example embodiments, the output is the ultrasound image 208 on the GUI. In certain example embodiment, the method 400 also includes displaying a CT image through the GUI when the one or more selection inputs includes a CT file selection (step 416). In certain example embodiments, a method may include any subset of these steps, and can be performed in any order.

According to one example embodiment, the present system and method provide users with a virtual learning experience about a specific human anatomy. The user learns how real endoscopes and their accessories work through practice on a virtual device. The present system and method may be used to help a user (e.g., surgeon, medical practitioner) understand and train through a procedure. For example, a biopsy to confirm a cancer diagnosis requires use of Endobronchial Ultrasound Transbronchial Needle Aspiration (“EBUS-TBNA”). According to one embodiment, the present system and method do not require a dedicated hardware, making the simulation portable and accessible. The system includes an array of virtual devices based on real scopes and accessories and provides an affordable solution compared to a hardware-based simulation that is currently available in the market. According to one example embodiment. the present 3D human anatomy model as well as the endoscopic devices and accessories are built using a virtual reality game engine. The user experience (“UX”) and graphical user interface (“UI”) are carefully designed for intuitiveness and user-friendliness. According to one embodiment, the present system and method provide animations of an anatomy model. Exemplary animations include, but are not limited to, movements of different parts of the EBUS-TBNA needle, movements of balloon, catheter and needle in the internal bronchial tree, back to initial position, and needle movements in ultrasound view.

Although embodiments of the present disclosure have been described herein in detail, the descriptions are by way of example. The features of the disclosure described herein are representative and, in alternative embodiments, certain features and elements may be added or omitted. Additionally, modifications to aspects of the embodiments described herein may be made by those skilled in the art without departing from the spirit and scope of the present disclosure defined in the following claims, the scope of which are to be accorded the broadest interpretation so as to encompass modifications and equivalent structures.

What is claimed is:

1. A computer-implemented system for providing endoscopic simulations, comprising:
a 3D organ model; and
a graphical user interface (GUI) displayed on a display, the GUI comprising:
a device model simulating a medical device displayed in the GUI and configured to be manipulated by a first user input to the GUI,
an internal view of the 3D organ model, wherein the internal view is controlled by the manipulation of the device model and simulates a view captured by the simulated medical device; and
an external view of the 3D organ model, wherein the external view is controlled by a second user input to the GUI.

2. The computer-implemented system of claim 1, wherein the GUI further comprises an ultrasound image, wherein the ultrasound image is at least partially controlled by the manipulation of the device model.

3. The computer-implemented system of claim 1, wherein the GUI further comprises a CT image.

4. The computer-implemented system of claim 1, wherein the GUI further comprises another simulated graphical or numerical output of the simulated medical device or device model.

5. computer-implemented system of claim 1, wherein the external view of the 3D organ model comprises an indication of a simulated location of the simulated medical device or device model.

6. The computer implemented system of claim 1, wherein the GUI is displayed on a touchscreen, and the first user input comprises a touch action on the portion of the GUI comprising the device model.

7. The computer-implemented system of claim 1, wherein the touch action simulates any one or combination of the following: depressing a button, controlling a joystick, twisting a knob, actuating an accessory, and moving the medical device.

8. A computer-implemented system for providing medical device simulations, comprising:
a graphical user interface (GUI) configured to receive one or more user inputs;
a device module configured to receive an input from the GUI in accordance with a first user input of the one or more user inputs, the device module comprising a 3D device model of a medical device, the 3D device model displayed in the GUI, wherein a display angle and configuration of the 3D device model is determined based on the first user input, and wherein the first user input includes a simulated use of the medical device; and
an organ module configured to receive an input from the GUI, the device module, or both, in accordance with the first user input to the device module, the organ module comprising:
a 3D organ model;
an internal organ sub-module comprising an internal view of the 3D organ model. wherein the internal view changes according to the first use input to the device module; and
an external organ sub-module comprising an external view of the 3D organ model, the external organ sub-module configured to receive at least one of an input from the device module, and an input from the GUI according to a second user input of the one or more user inputs, wherein an angle and configuration of the external view is changeable according to the second user input or the input from the device module.

9. The computer-implemented system of claim 8, comprising:
an ultrasound module comprising an ultrasound image displayed in the GUI, wherein the ultrasound module receives an input from the device module in accordance with the first user input, and the ultrasound image changes in accordance with the first user input.

10. The computer-implemented system of claim 8, comprising:
a CT module comprising a CT image displayed in the GUI, the CT image selected via a third user input of the one or more user inputs.

11. The computer implemented system of claim 8, wherein the medical device is an endoscopy device.

12. The computer-implemented system of claim 8, wherein manipulation of the 3D device model of the medical device comprises any of the following: swiping over the 3D device model of the medical device, touching a portion of the 3D device model of the medical device for a period of time, multi-point touch of the 3D device model of the medical device, and dragging a portion of the 3D device model of the medical device.

13. The computer implemented system of claim 8, wherein the GUI is a touch-screen interface and the one or more user inputs comprise a user touch.

14. The computer-implemented system of claim 8, wherein the simulated use of the medical device includes any one or combination of the following: depressing a button, controlling a joystick, twisting a knob, actuating an accessory, and moving the medical device.

15. A method of simulating endoscopy, comprising:
receiving one or more selection inputs from a user, the one or more selection inputs comprising at least one of a device selection, an accessory selection, or an organ selection;
displaying a graphical user interface (GUI) on a screen according to the received one or more selection inputs, wherein the graphical user interface includes a graphical model of a medical device and a graphical model of an organ;
receiving a control input to the GUI, the control input comprising a manipulation of the graphical model of the medical device;
displaying a real-time configuration of the graphical model of the medical device based on the control input; and
displaying a real-time configuration of the graphical model of the organ based on the control input.

16. The method of simulating endoscopy of claim 15, comprising:
displaying a real-time output of an. ultrasound module through the GUI based on the control input when the control input includes an ultrasound action.

17. The method of simulating endoscopy of claim 15, comprising:
displaying a CT image through the GUI when the one or more selection input includes a CT file selection.

18. The method of simulating endoscopy of claim 15, comprising:
displaying the GUI on a touchscreen; and
receiving the control input on the touchscreen.

19. The method of simulating endoscopy of claim 15, wherein manipulation of the graphical model simulates one or any combination of the following: depressing a button, controlling a joystick, twisting a knob, actuating an accessory, and moving the medical device.

20. The method of simulating endoscopy of claim 18, wherein manipulation of the graphical model of the medical device comprises any of the following: swiping over the graphical model of the medical device, touching a portion of the graphical model of the medical device for a period of time, multi-point touch of the graphical model of the medical device, dragging a portion of the graphical model of the medical device.
